(19) United States
(12) Patent Application Publication
(10) Pub. No.: US 2013/0319884 A1
(43) Pub. Date: Dec. 5, 2013

(54) ACCESSORIES FOR SEATING DEVICES

(71) Applicant: MARK GOMEZ, Valencia, CA (US)

(72) Inventor: MARK GOMEZ, Valencia, CA (US)

(21) Appl. No.: 13/896,229

(22) Filed: May 16, 2013

Related U.S. Application Data
(60) Provisional application No. 61/655,631, filed on Jun. 5, 2012.

(51) Int. Cl. F16M 13/06; F16M 13/00; F16M 13/02

(52) U.S. Cl. CPC F16M 13/06; F16M 13/022; F16M 13/00
USPC 206/216; 248/558; 108/28; 248/274.1

(57) ABSTRACT

An apparatus for entertaining comprising a tray configured to attach to a seat; a securing means for securing the tray to the seat; and an entertainment device holder configured to be mounted to the tray, the entertainment device holder including a first wall member, a second wall member opposite the first wall member, and a connecting member in between the first wall member and the second wall member, the connecting member being configured to accommodate the entertainment device.

### CROSS-REFERENCE TO RELATED APPLICATIONS

This application claims the benefit of U.S. provisional Application No. 61/655,631 filed Jun. 5, 2012, the disclosure of which is incorporated in its entirety by reference herein.

### TECHNICAL FIELD

The present disclosure relates to accessories for seating devices, in particular accessories that assist in entertaining a user.

### BACKGROUND

Young children can become a tremendous distraction and disruption for parents during meal time. This is especially true if the young child is accompanying the parents to a meal at a public restaurant where other patrons are trying to enjoy a quiet meal. Young children are known to cry and scream and be otherwise uncooperative when the parents are attempting to feed the child during meal time. At other times, the young child is fed first, and then seated at the table while the parents and other members of the family sit down to enjoy their meals.

Parents have often resorted to providing the young child with various toys or otherwise preoccupying the child with various entertainment devices such as portable video players or music players during the meal which is held in place by a parent to prevent the toys from being dropped, or to prevent damage to electronic devices which are usually very valuable. However, this is not conducive to an enjoyable meal for others seated at the table, and is especially inconvenient when the child is taken to a public restaurant. Furthermore, young children are often seated in a child booster seat or in a high chair when seated at a table for a meal both at home and in public restaurants. While a child is seated in a high chair, toys are often misplaced or dropped onto unsanitary surfaces, such as the floor, which poses health risks when feeding a child and pose a great risk for damaging valuable toys and electronic devices.

### SUMMARY

The present disclosure provides an apparatus that assists in providing entertainment and that includes, among other things, a foldable tray including a plurality of hingeably connected sections, the hingeably connected sections configured to fold towards each other and form a storage unit, the tray defining a plurality of recesses; an entertainment means for entertaining a child configured to be mounted to the tray; and an attachment assembly connected to the entertainment means, the attachment assembly including a leg member configured to insert to one of the plurality of recesses on the tray and a lock member attached to the leg member, the lock member configured to abut a surface of the tray to secure the leg member to the tray, wherein the storage unit is configured to provide storage for the entertainment means and the attachment assembly.

The present disclosure also includes an apparatus that assists in providing entertainment and that includes, among other things, a tray defining a plurality of recesses; an attachment assembly including a leg member configured to insert to one of the plurality of recesses on the tray and a lock member attached to the leg member, the lock member configured to abut a surface of the tray to secure the leg member to the tray; and an entertainment device holder attached to the attachment assembly, the entertainment device holder comprising a first wall member and a second wall member configured to support an entertainment device and a connecting member in between the first wall member and the second wall member, the connecting member being configured to accommodate the entertainment device.

The present disclosure further includes an apparatus that assists in providing entertainment and that includes, among other things, a tray configured to attach to a seat; a securing means for securing the tray to the seat; and an entertainment device holder configured to be mounted to the tray, the entertainment device holder including a first wall member, a second wall member opposite the first wall member, and a connecting member in between the first wall member and the second wall member, the connecting member being configured to accommodate the entertainment device.

The present disclosure also includes an entertainment device holder that includes a first wall configured to support an entertainment device; a second wall configured to move towards and away from the first wall; and a distance control mechanism configured to allow the distance of the second wall relative to the first wall to be adjusted, the distance control mechanism includes: at least one rail connected to the second wall, the rail including a plurality of grooves; a locking pin positioned adjacent to the plurality of grooves and configured to insert to one of the plurality of grooves; and a locking pin switch configured to move the locking pin away from the plurality of grooves, wherein the distance between the first wall and the second wall can be adjusted to accommodate various types of entertainment devices.

### BRIEF DESCRIPTION OF THE DRAWINGS

FIG. 1 is substantially a perspective view of an exemplary apparatus of the present disclosure attached to a seat;

FIG. 2 is substantially a view of the exemplary apparatus of FIG. 1 in a folded position and with some of the apparatus components stored within the storage unit formed by the tray.

FIG. 3 is substantially a view of an underside of the apparatus showing an exemplary set of tray securing members.

FIG. 4 is substantially a view of the exemplary set of tray securing members of FIG. 3 attached to a hand bar of a high chair.

FIG. 5 is substantially a view of an underside of another exemplary apparatus of the present disclosure.

FIG. 6a is substantially a schematic view of an exemplary tray and exemplary attachment assemblies.

FIG. 6b is substantially a view of a bottom surface of a tray showing a lock member of the attachment assembly abutting the bottom surface.

FIG. 7a is substantially a perspective view of an exemplary apparatus with an exemplary entertainment device holder in a particular position.

FIG. 7b is substantially a perspective view of the exemplary apparatus of FIG. 7a with the entertainment device holder in a position different from the position shown in FIG. 7a.

FIG. 7c is substantially a cross-section view taken from FIG. 7b.

FIG. 8 is substantially a perspective view of a tray attached to a high chair and with an entertainment device holder holding a tablet computer.

FIG. 9 is substantially side view of yet another embodiment of an entertainment device holder.

FIG. 10a is substantially a bottom view of the entertainment device holder of FIG. 9 showing a locking pin engaged to one of the plurality of grooves of the moveable rail.

FIG. 10b is substantially a bottom view of the entertainment device holder of FIG. 9 showing the locking pin being substantially disengaged from the rail allowing the rail to move.

FIG. 11 is substantially a partial rear view of the entertainment device holder of FIG. 9 showing a locking pin switch.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure includes various apparatus that assist in entertaining or preoccupying a user, such as a young child seated in a high chair, a car seat, or a booster chair. An apparatus may include a multitude of removable and interchangeable toys or other entertainment or educational devices for placement into a tray. The tray may define a multitude of placement recesses in which the entertainment or educational devices may be removeably attached. The tray surface may further include a defined space for placement of food, utensils, and beverages which the user may access and consume while seated. The tray is preferably configured to work with or be secured to a wide variety of seats, including high chairs, car seats, infant seats, and booster seats, so that the device may be used at home and taken to public places, such as restaurants. The tray may be configured to fold up into a smaller, portable package, and may be further configured to provide storage for the accompanying toys, entertainment or educational devices for easy portability.

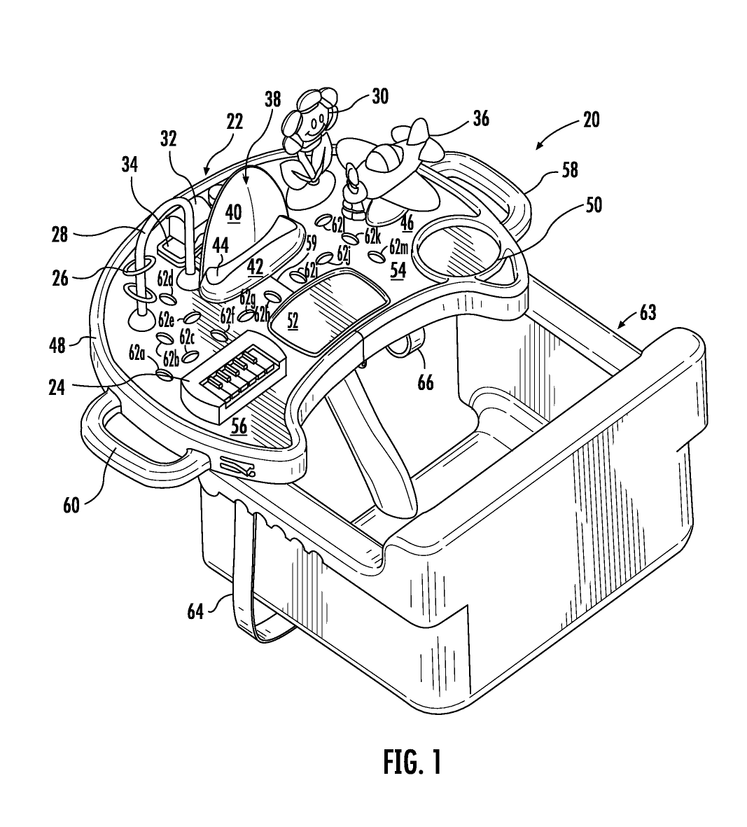

Referring now to FIG. 1, an exemplary apparatus 20 is depicted and includes a main tray 22 with a plurality of entertainment devices intended to entertain and preoccupy a seated user. The entertainment devices may include: a toy piano 24, toy rings 26 moveable about a raised track 28, toy cartoon flowers 30 or other assorted cartoon figures (not shown), toy trains 32 moveable about a track 34, toy airplanes 20 or other assorted vehicles (not shown), toy animals or other assorted cartoon faces (not shown), a rattle or other assorted noise making toys (not shown), a toy steering wheel (not shown), and any other toys known in the art (not shown). The apparatus 20 may also include entertainment devices in the form of electronic devices (not shown), such as mobile phones, computers, music players, video players, and tablet computers. As such, the apparatus 20 preferably includes an entertainment device holder 38, which may include a first wall 40, a second wall 42, and a connecting member 44 connecting the first wall 40 and the second wall 42. The connecting member 44 is preferably configured to accommodate an electronic device, which may lean upright on the first wall 40. The second wall 42 may be configured to assist in maintaining the upright position of the electronic device and controlling the movement of the electronic device. In certain embodiments, the connecting member 44 may be substantially perpendicular to the first wall 42 and the second wall. In yet other embodiments, the connecting member 44 may define a groove or a substantially U-shaped channel to further secure the electronic device.

The main tray 22 of the apparatus 20 preferably also includes a depressed surface 46 and a rim 48 surrounding the depressed surface 46. It can be realized that the depressed surface 46 and the rim 48 may aid in preventing items that are positioned on the tray from falling. The depressed surface 46 of the main tray 22 preferably defines a beverage holder rim 50, which is configured to hold beverage containers, such as cups, bottles, or cans. The apparatus 20 may also include feeding tray 52, which may be removeably attached to the main tray 22 and where food or eating utensils for the user may be placed.

The depressed surface of the main tray 22 preferably also defines multiple recesses 62a-m, which are part of the attachment assembly described below. The recesses 62a-m are preferably elliptical in shape and may vary in their orientations around the tray. For instance, some recesses are vertically oriented, such as recesses 62b, 62d, 62h, 62i, 62k and 62m. Some recesses are horizontally oriented, such as recesses 62a, 62c, 62g, 62j, and 62l. Of course, the shapes, numbers, and orientations of the recesses may vary. Utility devices (not shown), such as a baby rattle, a pacifier, eating utensils, such as forks and spoons, or baby bottles, may be provided and may be attached to a leash or tether and secured to a recess in the tray using the attachment assembly described below. The main tray 22 may be divided into two sides—first section 54 and second section 56.

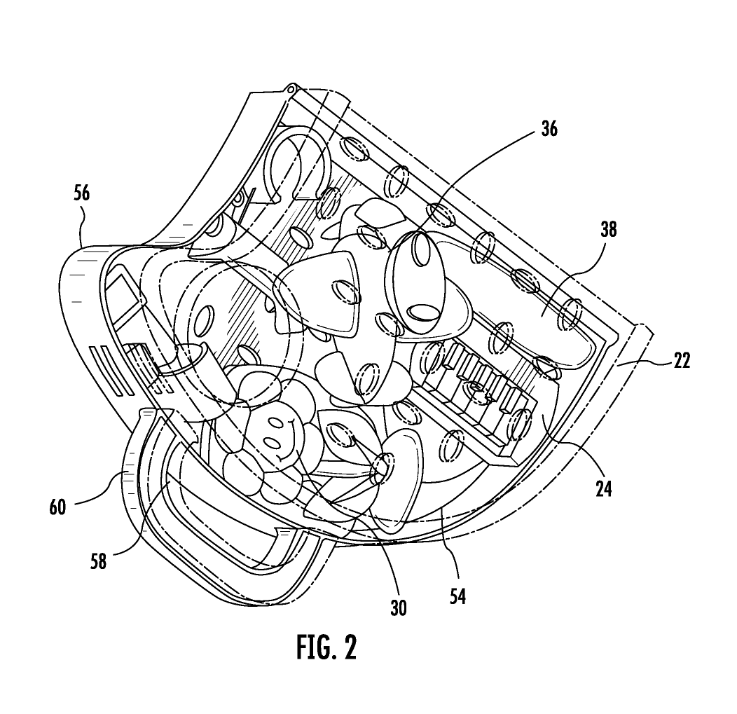

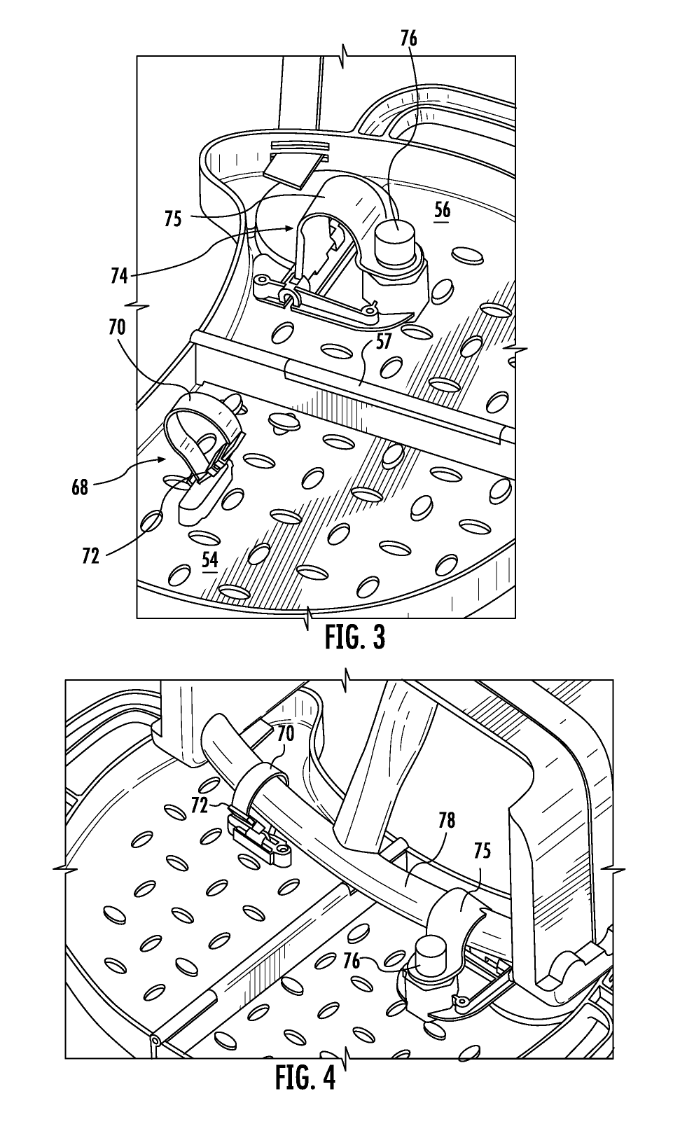

The main tray 22 is also preferably configured to be foldable, such as in half, for easy carrying and storage. Line 59 indicates a line where the two sections of the main tray 22 may be folded towards each other. The main tray 22 preferably further includes a first handle 58 attached to one side of the first section 54 and a second handle 60 attached to one side of the second section 56. Referring now to FIG. 2, the main tray 22 is shown to be in the folded position where the first section 54 folds towards second section 56 and the first handle 58 and the second handle 60 combines into a single handle. When the tray is in its folded position, the outer edges of the opposing folding sides of the tray may securely abut each other such as to define an encapsulated interior void within the folded tray. The opposing folding sides of the tray may be secured together by a securing mechanism, such as a buckle, hook, or latch (not shown). This interior void may be configured to serve as a storage unit where the entertainment devices, such as the toys and the electronic devices previously described, and the other components of the apparatus 20 may be stored. It can be appreciated that this feature makes it easy to bring the apparatus 20 for use anywhere, especially to public places. The handle formed from the first handle 58 and the second handle 60 may further allow a user to comfortably hold and carry the tray, along with any contents stored within the interior void, when in the folded position. Referring now to FIG. 3, the first section 54 and second section 56 of the main tray 22 are preferably hingeably connected via a hinge 57, which allow both sections to fold around line 59 (FIG. 1). Other folding mechanisms known in the art may be utilized to allow the sections to fold. The size and the number of hinges may also be varied. In other embodiments, the tray may be configured with more than one folding crease to allow for folding of the tray into smaller segments. The interior void may further include predetermined storage locations for each entertainment device wherein each device may be inserted and secured for transportation or storage.

Referring back to FIG. 1, the apparatus 20 preferably includes a tray securing member configured to secure the main tray 22 to a seat 63. As shown in FIG. 1, the tray securing member may be a first elongated adjustable strap 64 configured to be wrapped around the seat 63 from one side of the first section 54 of the main tray 22 to one side of the second section 56 of the main tray 22. The tray securing member may further include a second strap 66 configured to strap around a hand bar 78 of the seat 63 (FIG. 4) that is below the main tray 22.

Referring now to FIGS. 3 and 4, various types of tray securing members are shown. A tray securing member 68 may include a combination of a strap 70 and a release buckle 72 attached to an attachment assembly that is mounted to the main tray 22. Additional details of the attachment assembly are discussed below. Another tray securing member 74 may include the combination of a strap 75 and a strap fastener 76 attached also to the same attachment assembly. The strap fastener 76 may either be a screw-type fastener or a push-in type fastener that is configured to fasten the strap to the attachment assembly or to the underside of the tray. The tray securing members 68 and 74 may be attached to a hand bar 78 of a seating device, such as a high chair. In particular, the straps 70 and 75 may be strapped around the hand bar 78 and they may be secured to their respective release buckle 72 or strap fastener 76.

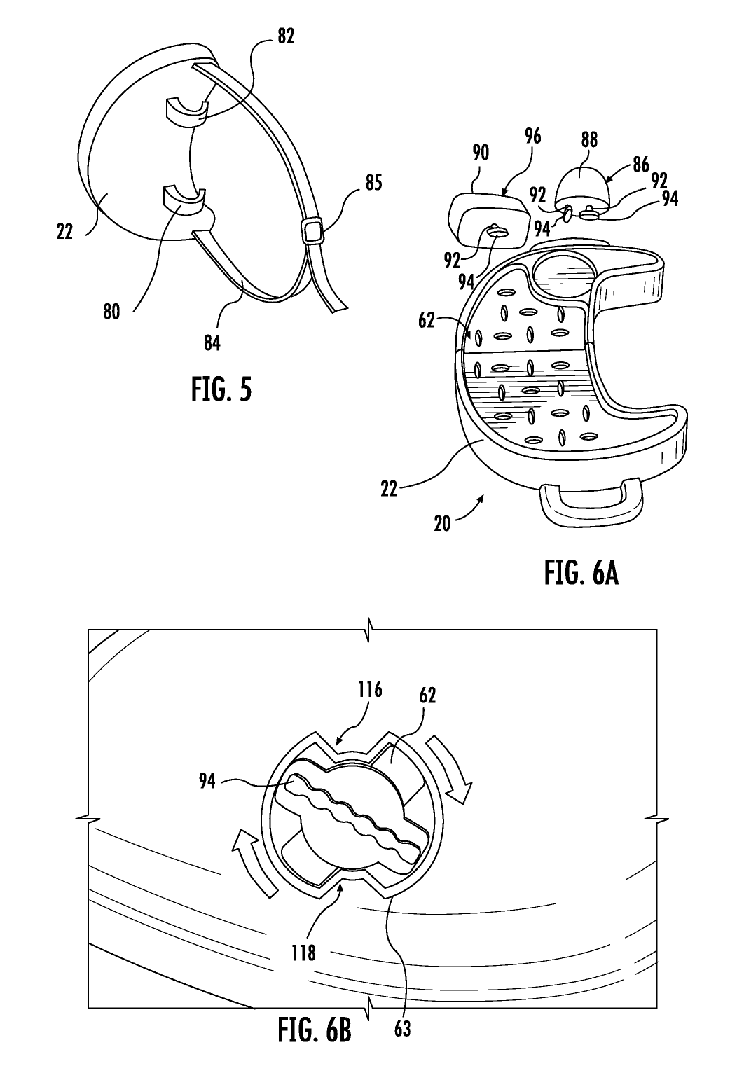

Referring now to FIG. 5, another embodiment of a tray securing member may include: a pair of hooks 80 and 82 configured to hook on to a portion of a seat, such as the hand bar 78 shown in FIG. 3, and an adjustable belt 84 with a buckle 85. Various types of buckles known in the art may be used to allow the belt to be adjusted, including insert buckles or connector buckles. Various configurations of the securing members are possible and contemplated by the present invention, but it will be understood by those with ordinary skill in the art that said securing members will be configured to allow the user to secure the tray to a wide variety of different high chair designs. By way of example, the securing members may be configured to secure the tray to the high chair by securing to arm rests which may be provided by a high chair design. In another embodiment, the securing members may be configured to secure the tray to the high chair by securing to the horizontal eating surface provided by a high chair design. Said securing members may utilize a screw-in mechanism, such as a vice design, which securely tightens gripping arms about a structure of a high chair. In another embodiment, the securing members may include gripping arms biased in a closed securing position by a biasing mechanism, said gripping arms movable to a second open position, for placement about a structure of a high chair. In other embodiments, the securing members may be removable and interchangeable with other configurations of securing members compatible with the tray to allow for universal compatibility with all high chair designs. Where secure attachment to a high chair is not possible, or where the system may be used without a high chair, the system of the present invention may include standalone supports for the tray to allow the tray to be supported solely by said supports in close proximity to the young child seated in a non-compatible high chair.

The attachment assembly will now be described using FIG. 6a where an exemplary main tray 22 is shown with all entertainment devices removed from the tray. The attachment assembly preferably includes an attachment base 86 configured to be attached to an entertainment device previously described, at least one leg member 92 attached to the attachment base 86, and at least one lock member 94 preferably perpendicularly attached to the leg member 92. The entertainment device may attached to the attachment base by various methods, such as by providing threads on the entertainment device and the base or by providing retaining clips or tabs with matching receivers (not shown). The leg member 92 and the lock member 94 are preferably configured to insert through a recess 62 of the tray 22. The attachment assembly may then be twisted to a predetermined number of degrees in clockwise or counterclockwise direction so the lock member 94 may abut the underside of the tray and prevent the attachment assembly and the corresponding entertainment device attached to it from being removed from the tray 22.

The entertainment device and its respective attachment assembly may be configured to be removed by rotating the entertainment device to a predetermined number of degrees, and exerting a vertically directed force to remove the device. Various forms of attachment assemblies may be provided, which may vary on the shapes of the attachment bases and the number of leg and lock members. For instance, on FIG. 6a, attachment assembly may include a dome shaped base 88 with a pair of leg members 92 and a pair of corresponding lock members 94. Attachment assembly 96 may include a rectangular shaped base 90 with a single leg member 92 and corresponding lock member 94.

Referring now to FIG. 6b, the underside of a tray 22 may define a lock member guide 63 surrounding some or all of the recesses 62. The lock member guide 63 may be a protruding member configured to limit the rotation of the lock member. For instance, the lock member guide 63 may include a modified circular rim protruding from the underside of the tray. The modified circular rim may include a pair of lock member stops 116 and 118 formed on the opposing periphery of modified circular rim. Each of the lock member stops are preferably configured to restrict the movement of the lock member to minimize the occurrence of the attachment assembly detaching from the tray 22. For instance, the lock member 94 shown in FIG. 6b is restricted to moving within approximately 30 to 150 degrees on one end or 210 to 330 on the other end. The shape of the lock member guide 63 and the lock member stops may be varied. In other embodiments, only a pair of stops may be provided to prevent the lock member from rotating to a full circle.

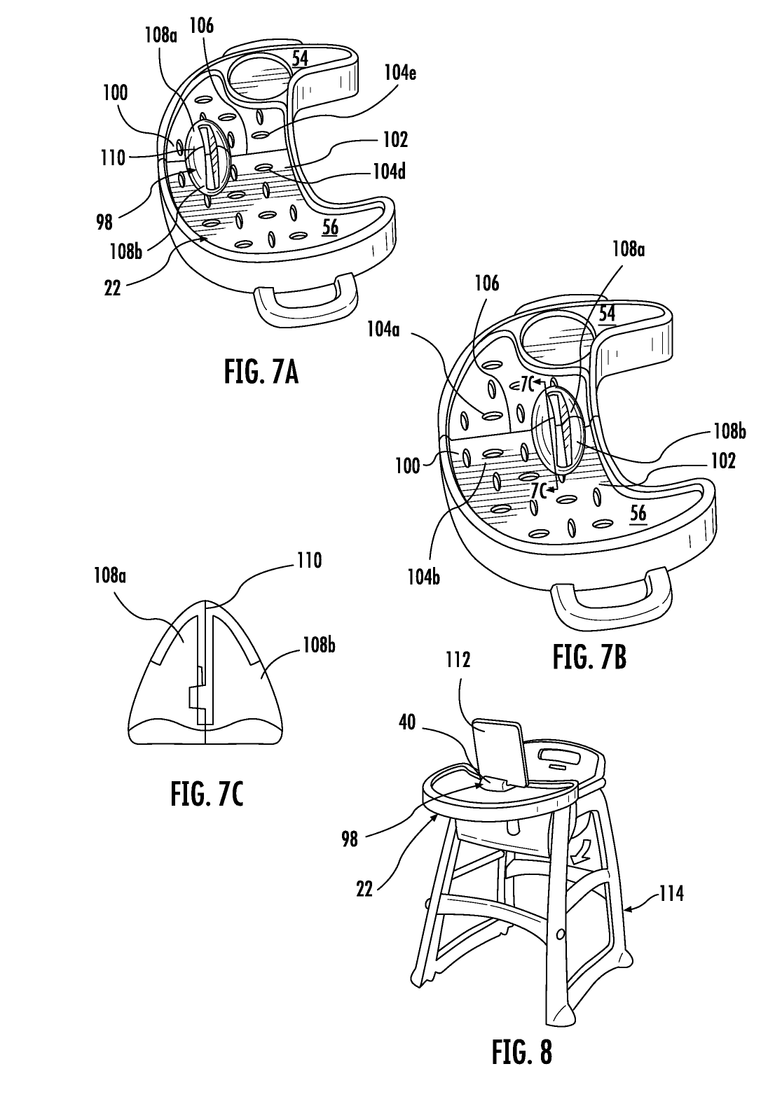

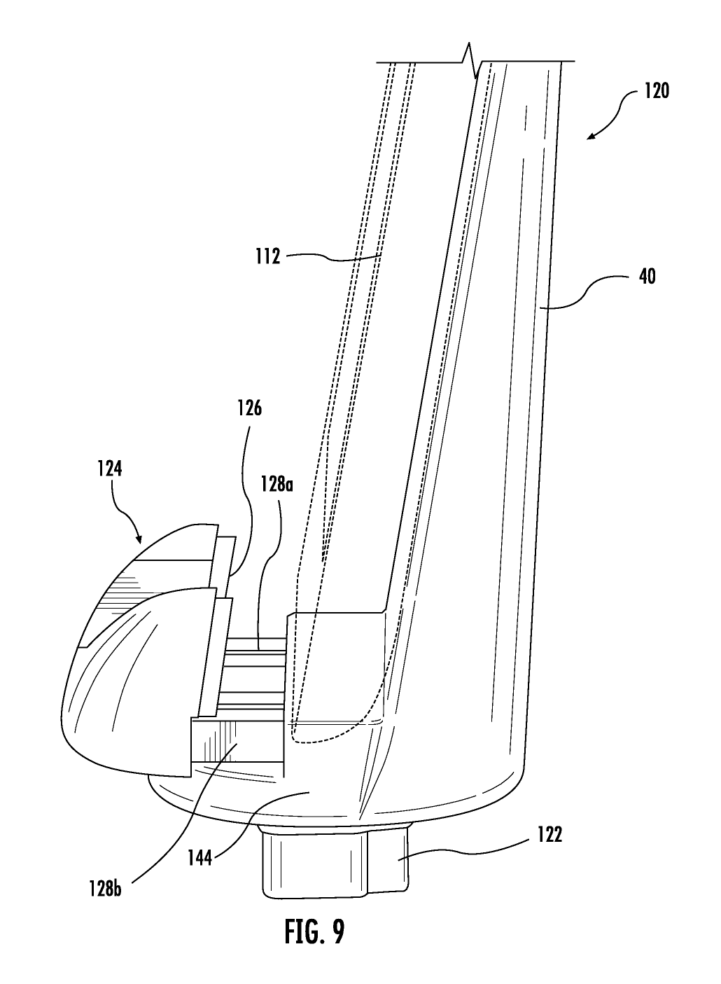

The plurality of recesses 62 may be arranged on the tray such that a group of recesses may be used to accommodate entertainment devices that may require more than one corresponding recesses. For example, a group of recesses may be prearranged to accommodate a toy car and associated track that extends in a substantially lengthwise direction and include more than one attachment assembly. Referring now to FIGS. 7a and 7b, an entertainment device holder 98 is provided and preferably includes an attachment assembly that has a leg and lock member that goes through a recess 104a on first section 54 and another leg and lock member that goes through recess 104b on section 56. The entertainment device holder 98 may be adjustably positioned at various places on the tray, such as adjacent to the front end 100 (shown in FIG. 7a) or adjacent to the rear end 102 (shown in FIG. 7b). The position of the entertainment device holder 98 can be adjusted to go from the front end 100 to the rear end 102 by moving the entertainment device holder 98 so that the leg and lock members of its attachment assembly are inserted from recesses 104a and 104b to recesses 104c and 104d. It is noted that the entertainment device holder 98 may be positioned to span across the folding area 106 of sections 54 and 56. It can be realized that the stability of the tray may be enhanced by positioning the entertainment device holder 98 across the folding area 106.

In other embodiments, the entertainment device holder 98 may be configured to fold with the tray. For instance, the entertainment device holder 98 may be divided into two parts—part 108a and part 108b—configure to fold at junction 110. Referring now to FIG. 7c, parts 108a and 108b may be joined via a projecting tab 112 defined by part 108b and a notch defined by part 108a when in an unfolded position. Various ways of joining parts 108a and 108b may be utilized.

Referring now to FIG. 8, the entertainment device holder 98 is shown to be attached to the main tray 22. An electronic device in the form of a tablet computer 112 is shown to be positioned on the entertainment device holder 98 such that the tablet computer 112 rests on the first wall 40 of the entertainment device holder 98. The tray 22 is also shown to be attached to a conventional high chair 114.

Referring now to FIG. 9, yet another exemplary entertainment device holder is 120 shown. Entertainment device holder 120 preferably also includes an attachment assembly 122 for attaching the entertainment device holder 120 to a tray (not shown), a first wall 40 for supporting an entertainment device substantially upright, such as a tablet computer 112, and a connecting member 44 that serves as a base for the entertainment device and a second wall 124. The entertainment device holder 120 preferably includes a moveable second wall 124 configured to substantially control the placement of the entertainment device within the connecting member 44, or the viewing angle of the entertainment device. The second wall 124 preferably includes a functional vertical surface 126, which may be in a form of rubber adapted to grip and provide cushion to the entertainment device or a cushion material, such as a felt or cloth, configured to abut against the entertainment device to the hold it in place while protecting it from potential scratches.

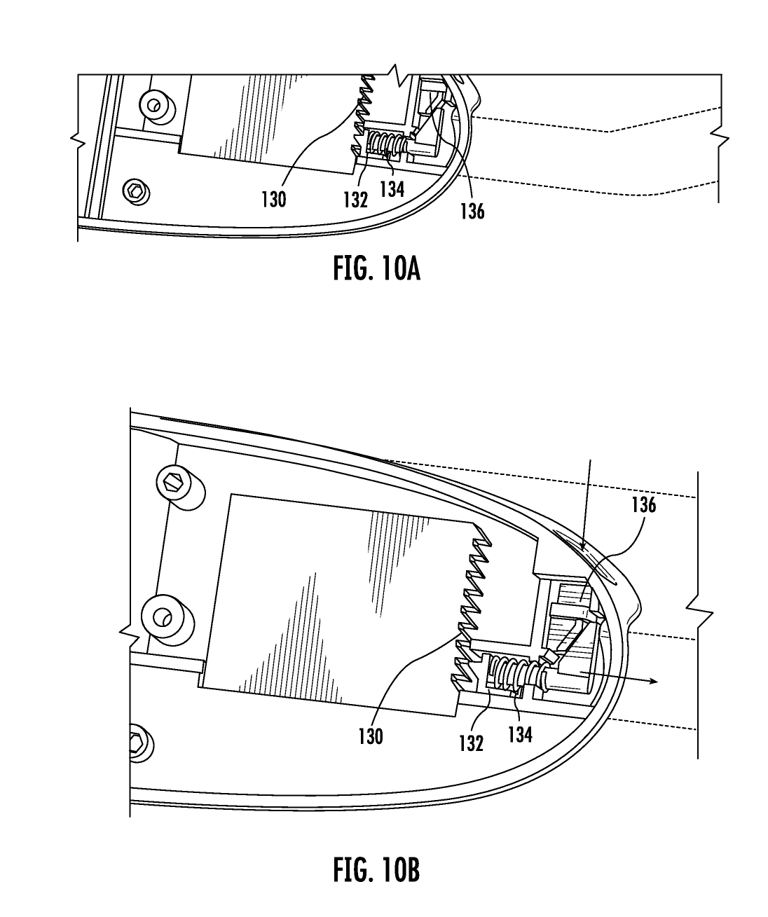

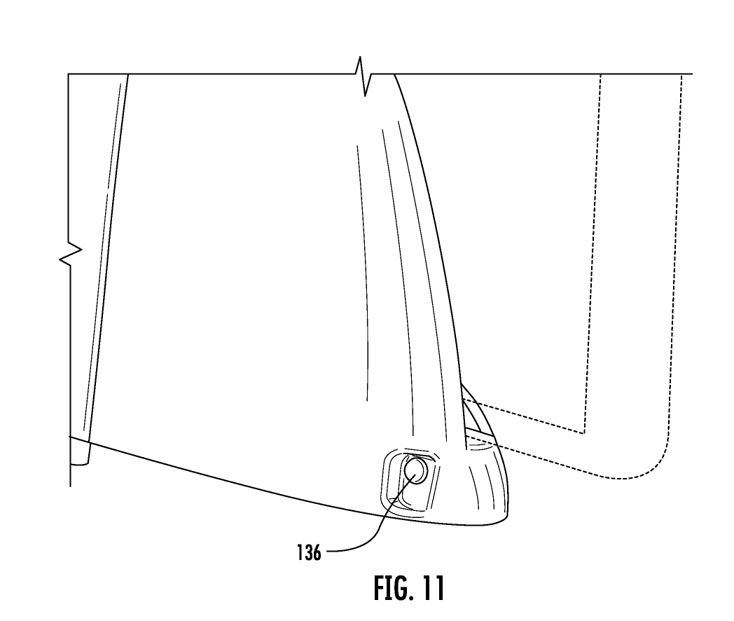

The moveable second wall 124 preferably also includes a pair of moveable rails 128a and 128b substantially perpendicularly attached to the second wall 124 and configured to move on the connecting member 44 and within certain areas of the connecting member 44. The moveable rails 128a and 128b preferably include a distance control mechanism that allows the distance between the first wall 40 and the second wall 124 to be adjusted. Referring now to FIGS. 10a and 10b, the distance control mechanism preferably includes a plurality of teeth 130 formed on at least one side of the rails (128a, 128b, or both) and that defines a plurality of grooves. The distance control mechanism preferably also includes a locking pin 132 that is biased to engage with one of the plurality of grooves by a biasing device 134, such as a spring. The locking pin 132 may be moved away from the plurality of grooves by pressing on a locking pin switch 136.

The locking pin switch 36 preferably appears as a button at the back of the entertainment device holder 120 (FIG. 11). The switch 136 preferably extends towards the bottom of the entertainment device holder 120 and adjacent to the locking pin 132. When the switch 136 is pressed, the switch 136 preferably pushes the locking pin 132 away from the plurality of grooves thereby freeing up the moveable rails to allow the second wall 124 to be moved closer to or away from the first wall 40. Once the moveable rails or the second wall 124 is at a desired position relative to the first wall 40, the switch 136 may be released to allow the locking pin 132 to be engaged into a groove among the plurality of grooves, which subsequently locks the moveable rails and the moveable second wall 124 in place.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An apparatus comprising:
a foldable tray including a plurality of hingeably connected sections, the hingeably connected sections configured to fold towards each other and form a storage unit, the tray defining a plurality of recesses;
an entertainment means for entertaining a child configured to be mounted to the tray; and
an attachment assembly connected to the entertainment means, the attachment assembly including: a leg member configured to insert to one of the plurality of recesses on the tray and a lock member attached to the leg member, the lock member configured to abut a surface of the tray to secure the leg member to the tray, wherein the storage unit is configured to provide storage for the entertainment means.

2. The apparatus of claim 1 wherein the entertainment means is a toy.

3. The apparatus of claim 1 wherein the entertainment means is a mobile phone.

4. The apparatus of claim 1 wherein the entertainment means is a tablet computer.

5. The apparatus of claim 1 further comprising an entertainment device holder attached to the attachment assembly, the entertainment device holder comprising a first wall member, a second wall member opposite the first wall member, and a connecting member in between the first wall member and the second wall member, the connecting member being configured to accommodate the entertainment device.

6. The apparatus of claim 1 wherein the foldable tray further comprises a first section, a second section, a first handle connected to the first section, and a second handle connected to the second section, wherein when the tray is folded, the first handle and the second handle are configured to combine into a single handle.

7. The apparatus of claim 1 further comprising a securing means for securing the tray to a chair.

8. The apparatus of claim 7 wherein the securing means includes a pair of hooks attached to an underside of the tray, the pair of hooks configured to hold a hand bar of a high chair.

9. The apparatus of claim 7 wherein the securing means includes a strap attached to the attachment assembly, the strap configured to hold a hand bar of a high chair.

10. An apparatus comprising:
a tray defining a plurality of recesses;
an attachment assembly including a leg member configured to insert to one of the plurality of recesses on the tray and a lock member attached to the leg member, the lock member configured to abut a surface of the tray to secure the leg member to the tray; and
an entertainment device holder attached to the attachment assembly, the entertainment device holder comprising a first wall member and a second wall member configured to support an entertainment device and a connecting member in between the first wall member and the second wall member, the connecting member being configured to accommodate the entertainment device.

11. The apparatus of claim 10 wherein the entertainment device is a tablet computer.

12. The apparatus of claim 10 wherein the entertainment device is a mobile phone.

13. The apparatus of claim 10 wherein the tray includes a plurality of foldable sections, the foldable sections configured to form a storage unit, wherein the storage unit is configured to store the entertainment device.

14. The apparatus of claim 10 further comprising a plurality of toys, each of the plurality of toys including its own attachment assembly, each attachment assembly including a leg member configured to insert to one of the plurality of recesses on the tray and a lock member attached to the leg member, the lock member configured to abut a surface of the tray to secure the leg member to the tray.

15. An apparatus comprising:
a tray configured to attach to a seat;
a securing means for securing the tray to the seat; and
an entertainment device holder configured to be mounted to the tray, the entertainment device holder including a first wall member, a second wall member opposite the first wall member, and a connecting member in between the first wall member and the second wall member, the connecting member being configured to accommodate the entertainment device.

16. The apparatus of claim 15 wherein the securing means includes a pair of hooks attached to tray, the pair of hooks configured to hold the seat.

17. The apparatus of claim 16 wherein the tray is configured to attach to a high chair, the high chair including a hand bar, the pair of hooks configured to hold the hand bar.

18. The apparatus of claim 15 wherein the tray defines a plurality of recesses and the securing means includes a strap, the apparatus further comprising an attachment assembly including a leg member configured to insert to one of the plurality of recesses on the tray and a lock member attached to the leg member, the lock member configured to abut a surface of the tray to secure the leg member to the tray; the strap being attached to the attachment assembly and configured to hold the seat.

19. The apparatus of claim 15 wherein the tray further comprises a first section, a second section configured to fold towards the first section, a first handle connected to the first section, and a second handle connected to the second section, wherein when the second section is folded towards the first section, the first handle and the second handle are configured to combine into a single handle.

20. An entertainment device holder comprising:
a first wall configured to support an entertainment device;
a second wall configured to move towards and away from the first wall; and
a distance control mechanism configured to allow the distance of the second wall relative to the first wall to be adjusted, the distance control mechanism comprising:
at least one rail connected to the second wall, the rail including a plurality of grooves;
a locking pin positioned adjacent to the plurality of grooves and configured to insert to one of the plurality of grooves; and
a locking pin switch configured to move the locking pin away from the plurality of grooves, wherein the distance between the first wall and the second wall can be adjusted to accommodate various types of entertainment devices.
